(19) United States
(12) Patent Application Publication
(10) Pub. No.: US 2025/0280453 A1
(43) Pub. Date: Sep. 4, 2025

(54) SELECTION OF RESOURCE SETS FOR RANDOM ACCESS PROCEDURES

(71) Applicant: Lenovo (United Stateds) Inc., Morrisville, NC (US)

(72) Inventors: Alexander Golitschek Edler von Elbwart, Darmstadt (DE); Hyejung Jung, Palatine, IL (US); Joachim Löhr, Wiesbaden (DE); Prateek Basu Mallick, Dreieich (DE)

(21) Appl. No.: 19/210,718

(22) Filed: May 16, 2025

(51) Int. Cl. H04W 74/0838; H04W 74/00

(52) U.S. Cl. CPC H04W 74/0838; H04W 74/006

(57) ABSTRACT

Various aspects of the present disclosure relate to configuring a user equipment (UE) to select a set of resources for random access based on a criterion or criteria, where a set of resources is a set of time and/or frequency resources for a random access transmission (e.g., a random access preamble). The criteria may be associated with and/or represent a priority for the set of resources with respect to an associated random access feature, feature combination, spatial relation, and so on. The UE may be configured with multiple sets of resources, such as a default set of resources and one or more auxiliary sets of resources. During a random access transmission, the UE may utilize the default set of resources and/or be activated and/or instructed to utilize an auxiliary set of resources.

### TECHNICAL FIELD

The present disclosure relates to wireless communications, and more specifically to the selection of resource sets for random access procedures.

### BACKGROUND

A wireless communications system may include one or multiple network communication devices, which may be otherwise known as network equipment (NE), supporting wireless communications for one or multiple user communication devices, which may be otherwise known as user equipment (UE), or other suitable terminology. The wireless communications system may support wireless communications with one or multiple user communication devices by utilizing resources of the wireless communications system (e.g., time resources (e.g., symbols, slots, subframes, frames, or the like) or frequency resources (e.g., subcarriers, carriers, or the like)). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

### SUMMARY

As used herein, including the claims, an article “a” before an element is unrestricted and understood to refer to “at least one” of those elements or “one or more” of those elements. The terms “a,” “at least one,” “one or more,” and “at least one of one or more” may be interchangeable.

As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.

As used herein, including in the claims, a “set” may include one or more elements.

The present disclosure relates to methods, apparatuses, processors, and systems that enable the selection of resource sets for random access procedures, such as the selection of resource sets based on a criterion or criteria associated with or assigned to the resource sets. The methods, apparatuses, processors, and systems of the present disclosure each have several innovative aspects, no single one of which is solely responsible for the desirable features disclosed herein.

A UE for wireless communication is described. The UE may be configured to, capable of, or operable to perform one or more operations as described herein. For example, the UE may comprise one or more memories and one or more processors coupled with the one or more memories and individually or collectively configured to cause the UE to select a set of resources of a plurality of sets of resources for random access based at least in part on criteria, and perform random access based at least in part on the selected set of resources.

A processor for wireless communication is described. The processor may be configured to, capable of, or operable to perform one or more operations as described herein. For example, the processor may comprise one or more memories and one or more controllers coupled with the one or more memories and individually or collectively configured to cause the processor to select a set of resources of a plurality of sets of resources for random access based at least in part on criteria, and perform random access based at least in part on the selected set of resources.

A method performed or performable by the UE is described. The method may comprise selecting a set of resources of a plurality of sets of resources for random access based at least in part on criteria, and performing random access based at least in part on the selected set of resources.

In some implementations of the UE, processor, and method described herein, the criteria comprise one or more of a feature associated with random access, a purpose associated with random access, a feature combination associated with random access, or spatial relation associated with random access, and wherein the set of resources is selected based at least in part on the feature associated with random access, the purpose associated with random access, the feature combination associated with random access, or the spatial relation associated with random access.

In some implementations of the UE, processor, and method described herein, the UE, processor, and method may further be configured to, capable of, performed, performable, or operable to receive a configuration for each of one or more sets of resources of the plurality of sets of resources, wherein the configuration is received in a radio resource control (RRC) message.

In some implementations of the UE, processor, and method described herein, the UE, processor, and method may further be configured to, capable of, performed, performable, or operable to receive information for each of one or more sets of resources of the plurality of sets resources, wherein the set of resources is selected based at least in part on the received information, and wherein the information is received in system information (SI), downlink control information (DCI), or a medium access control-control element (MAC-CE).

In some implementations of the UE, processor, and method described herein, the UE, processor, and method may further be configured to, capable of, performed, performable, or operable to determine a control resource set (CORESET) and receive the DCI based at least in part on the determined CORESET, wherein the DCI activates one or more sets of resources of the plurality of sets of resources, and wherein the set of resources is selected based at least in part on the received DCI.

In some implementations of the UE, processor, and method described herein, one or more of the received configuration or the received information indicates a respective periodicity associated with each of one or more sets of resources of the plurality of sets resources, indicates whether each of one or more sets of resources of the plurality of sets resources is activated or deactivated for random access, indicates a respective duration indicative of each of one or more sets of resources of the plurality of sets resources being activated or deactivated for random access, or a combination thereof.

In some implementations of the UE, processor, and method described herein, the UE, processor, and method may further be configured to, capable of, performed, performable, or operable to determine a type of random access procedure, wherein the type of random access procedure includes a contention-based random access procedure or a contention-free random access procedure, and wherein the criteria comprise the type of random access procedure, and wherein the set of resources is selected based at least in part on the determined type of random access procedure.

In some implementations of the UE, processor, and method described herein, the set of resources is selected based at least in part on a signal measurement value satisfying a threshold value, wherein the signal measurement value comprises a reference signal received power (RSRP) value, a reference signal strength indicator (RSSI) value, or both.

In some implementations of the UE, processor, and method described herein, the set of resources is selected irrespective of a signal measurement value satisfying a threshold value.

In some implementations of the UE, processor, and method described herein, each of one or more sets of resources of the plurality of sets resources is associated with a respective cell or a respective bandwidth part (BWP).

In some implementations of the UE, processor, and method described herein, the UE, processor, and method may further be configured to, capable of, performed, performable, or operable to receive a random access response during a random access procedure, wherein the random access response includes an indication of the set of resources, wherein the set of resources is selected based at least in part on the random access response and perform a random access transmission using the selected set of resources, wherein the selected set of resources are different than a respective set of resources associated with a previous random access transmission.

In some implementations of the UE, processor, and method described herein, the random access response is received via a physical downlink shared channel (PDSCH) and carries a MAC subheader that indicates the selected set of resources.

In some implementations of the UE, processor, and method described herein, the set of resources is selected based at least in part on an unsuccessful random access using a different set of resources, wherein the one or more processors are further individually or collectively configured to cause the UE to disable the different set of resources based at least in part on the selected set of resources.

In some implementations of the UE, processor, and method described herein, the UE, processor, and method may further be configured to, capable of, performed, performable, or operable to select the set of resources based at least in part on a statistic associated with the set of resources.

A network entity for wireless communication is described. The network entity may be configured to, capable of, or operable to perform one or more operations as described herein. For example, the network entity may comprise one or more memories and one or more processors coupled with the one or more memories and individually or collectively configured to cause the network entity to determine selection criteria for each of one or more sets of resources of a plurality of sets of resources for random access and transmit, to a UE, a configuration of the plurality of sets of resources for random access.

A method performed or performable by the network entity is described. The method may comprise determining selection criteria for each of one or more sets of resources of a plurality of sets of resources for random access and transmitting, to a UE, a configuration of the plurality of sets of resources for random access.

In some implementations of the network entity and method described herein, the network entity and method may further be configured to, capable of, performed, performable, or operable to

In some implementations of the network entity and method described herein, the plurality of sets of resources includes multiple sets of time or frequency random access channel (RACH) resources, wherein the network entity and method may further be configured to, capable of, performed, performable, or operable to transmit an activation signal that causes activation of at least one set of RACH resources for a certain duration.

In some implementations of the network entity and method described herein, the network entity and method may further be configured to, capable of, performed, performable, or operable to determine an occurrence of preamble collisions at a first set of resources of the plurality of sets of resources and transmit an indication to the UE to select a second set of resources for a subsequent random access procedure.

In some implementations of the network entity and method described herein, the network entity and method may further be configured to, capable of, performed, performable, or operable to transmit the configuration in SI, DCI, or a MAC-CE.

### BRIEF DESCRIPTION OF THE DRAWINGS

FIG. 1 illustrates an example of a wireless communications system in accordance with aspects of the present disclosure.

FIG. 2 illustrates an example of a signaling diagram in accordance with aspects of the present disclosure.

FIG. 3 illustrates an example of a signaling diagram in accordance with aspects of the present disclosure.

FIG. 4 illustrates an example of a UE in accordance with aspects of the present disclosure.

FIG. 5 illustrates an example of a processor in accordance with aspects of the present disclosure.

FIG. 6 illustrates an example of a NE in accordance with aspects of the present disclosure.

FIG. 7 illustrates a flowchart of a method performed by a UE in accordance with aspects of the present disclosure.

FIG. 8 illustrates a flowchart of a method performed by an NE in accordance with aspects of the present disclosure.

### DETAILED DESCRIPTION

An NE that supports some radio access technologies, such as 5G, may provision (e.g., transmit) a random access configuration (e.g., a random access channel (RACH) configuration) to a UE for various random access procedures, including initial access, connection re-establishment, handover, time alignment, system information requests, beam failure recovery, and so on. The NE may provide one or more RACH configurations in a cell-specific manner, such as via one or more parameters. One such parameter may include additionalRACH-ConfigList-r17. This parameter enables the NE to configure multiple additional RACH configurations for a cell or a bandwidth partition. For example, the NE may configure (e.g., determine) multiple RACH configurations, and each configuration may be associated with (e.g., allocated, assigned) a set of random access resources, where each set of random access resources is associated with a specific feature or feature combination. Thus, a specific random access resource (or set of random access resources) may assist the NE to identify which feature or feature combinations the UE supports via a random access procedure. In other words, when the UE initiate the random access procedure using a specific random access resource (or a set of random access resources), the NE can determine which feature or feature combinations the UE supports.

While some radio access technologies, such as 5G may associate a specific random access resource (or a set of random access resources) with a feature or feature combination and/or assign a priority to the specific random access resource (or a set of random access resources), these radio access technologies lack a mechanism for supporting or facilitating a prioritized selection or use of such random access resources associated with a specific feature or feature combination. For example, a UE may be unable to prioritize a subset of random access resources associated with a feature over another subset of random access resources associated with the feature, and/or to indicate/identify a set of random access resources the UE intends to use or select in response to collisions during a random access procedure.

Various aspects of the present disclosure relate to configuring a UE to select a set of resources for random access (e.g., resource sets) based on a criterion or criteria, where the set of resources is a set of time and/or frequency resources (also referred to herein as random access resources) for a random access transmission (e.g., a random access preamble). The criterion or criteria may be associated with and/or represent a priority for the set of resources with respect to an associated random access feature, random access feature combination, spatial relation, and so on. For example, the UE may determine, identify, retrieve, obtain, or otherwise be configured with multiple sets of resources, such as a default set of resources and one or more auxiliary (secondary, supplemental) sets of resources. During a random access procedure, the UE may utilize the default set of resources and/or an activated set of resources (e.g., an auxiliary set of resources).

As another example, the UE may be instructed to select a certain set of resources during a random access procedure. The UE may receive a random access response, during a random access procedure, that includes an indication of a set of resources to use for a subsequent random access transmission and perform the random access transmission using the selected set of resources (e.g., where the selected set of resources are different than a respective set of resources associated with a previous or original random access transmission).

Thus, the NE may configure a UE with multiple sets of resources and dynamically or responsively cause or instruct the UE to select a certain set of resources based on associated random access characteristics, running or ongoing random access procedures, and so on. In doing so, the NE may facilitate an efficient and effective use of random access resources during initial access and/or other random access procedures, among other benefits.

Aspects of the present disclosure are described in the context of a wireless communications system.

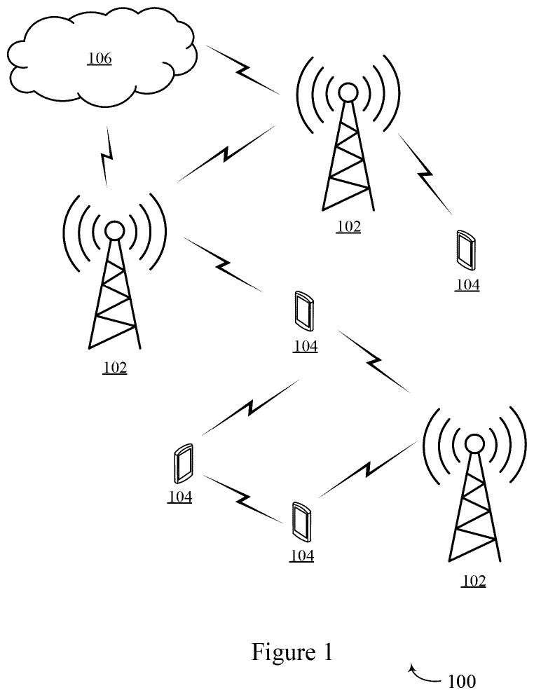

FIG. 1 illustrates an example of a wireless communications system 100 in accordance with aspects of the present disclosure. The wireless communications system 100 may include one or more NE 102, one or more UE 104, and a core network (CN) 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a NR network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NE 102 may be dispersed throughout a geographic region to form the wireless communications system 100. One or more of the NE 102 described herein may be or include or may be referred to as a network node, a base station, a network element, a network function, a network entity, a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NE 102.

The one or more UE 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N2, or network interface). In some implementations, the NE 102 may communicate with each other directly. In some other implementations, the NE 102 may communicate with each other or indirectly (e.g., via the CN 106. In some implementations, one or more NE 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NE 102 associated with the CN 106.

The CN 106 may communicate with a packet data network over one or more backhaul links (e.g., via an S1, N2, N2, or another network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally, or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHz), FR2 (24.25 GHz-52.6 GHz), FR3 (7.125 GHZ-24.25 GHz), FR4 (52.6 GHz-114.25 GHz), FR4a or FR4-1 (52.6 GHz-71 GHz), and FR5 (114.25 GHZ-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

In the wireless communications system 100, one or more NE 102 may provision multiple sets of resources (e.g., time and frequency random access resources) to one or more UEs 104, where each set of resources of the multiple sets of resources is associated with selection criteria. By way of example, an NE 102 may determine selection criteria for each of one or more sets of resources of a plurality of sets of resources for random access, and transmit, to a UE 104, a configuration of the plurality of sets of resources for random access. The UE 104 may receive, from the NE 102, the configuration of the plurality of sets of resources for random access. In some examples, the UE 104 may select a set of resources of a plurality of sets of resources for random access based at least in part on criteria, and perform random access based at least in part on the selected set of resources.

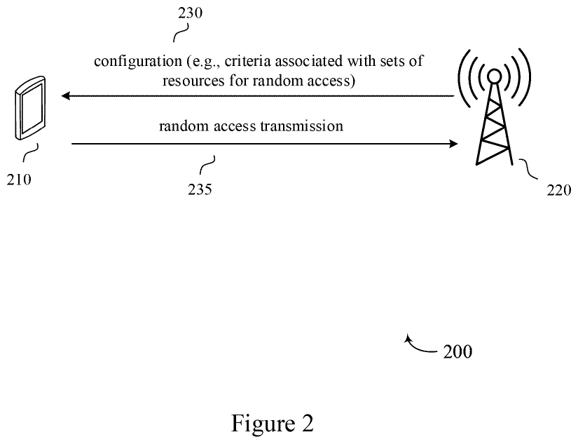

FIG. 2 illustrates an example signaling diagram 200 in accordance with aspects of the present disclosure. The signaling diagram 200 may implement or be implemented by aspects of the wireless communications system 100. The signaling diagram 200 may implement or be implemented by a UE 210 and a NE 220, which may be examples of a UE 104, and a NE 102 as described with reference to FIG. 1. Alternative examples of the following may be implemented, where some processes are performed in a different order than described or are not performed. In some cases, processes may include additional features not mentioned below, or further processes may be added.

The UE 210 may receive, and the NE 220 (e.g., a base station) may transmit, a configuration 230. The configuration 230 may include or indicate one or more criteria associated with multiple sets of resources for random access. In some cases, the configuration 230 may be common for all cells (e.g., a same configuration may be applicable for all cells in a network) or specific to one or more cells (e.g., a same configuration may be applicable for one or more specific cells, but not all cells in the network). Additionally, or alternatively, in some cases, the configuration 230 may be applicable for one or more BWPs. For example, different BWPs of a cell may have a same configuration or different configurations. Additionally, or alternatively, in some cases, the configuration 230 may be applicable for a group of UEs, based at least in part on one or more similar capabilities of the group of UEs, among others. Alternatively, the configuration 230 may be applicable for a single UE. For example, the configuration may be specific for the single UE, based on one or more capabilities of the UE, UE context, among others.

The UE 210 may obtain or receive a first (default) set of RACH resources and one or more second (auxiliary) sets of RACH resources. For example, the first set of RACH resources may not be associated with any specific purpose or any specific feature and may be selected and used by the UE 210 for any purpose and/or for any feature. At least one of the second sets of RACH resources may be associated with a specific purpose or a specific feature and may be selected by the UE 210 to perform the specific purpose or support the specific feature.

There may be a specific cause or reason for which the UE 210 initiates and/or performs a RACH procedure. Example purposes include, but is not limited to, an initial access from an RRC idle state, an RRC connection re-establishment procedure, a handover, a downlink data arrival or an uplink data arrival during an RRC connected state when a UL synchronization status is “non-synchronized” (i.e., the UE's 210 uplink transmissions are not time-aligned with the NE's 220 uplink timing expectations), a transition from an RRC inactive state to another RRC state (e.g., RRC idle state or RRC connected state), an establishment of time alignment during secondary cell (SCell) addition, a request for other SI, a beam failure recovery, an on-demand request for SIB1 or synchronization signal block (SSB), triggering a wake-up of a network element unit (e.g., a cell or the NE 220), etc.

The NE 220 may associate one or more features or feature combinations with a specific set of RACH resources to support access prioritization and/or feature identification. For example, the NE 220 may configure one or multiple physical random access channel (PRACH) occasions and corresponding preamble sets to be valid only for reduced capability (RedCap) UEs. Other examples, which may be indicated by a parameter, such as featurePriorities within a SIB1, may include RedCap, network slicing, small data transmission (SDT), random access Msg1 repetitions, random access Msg3 repetitions for coverage enhancements, among others.

Additionally, or alternatively, the NE 220 may indicate one or multiple set of RACH resources via configuration signaling. For example, the NE 220 may generate the configuration 230, such that the configuration 230 includes information (e.g., a parameter, information element (IE), etc.) that indicates the one or multiple set of RACH resources. Additionally, or alternatively, the NE 220 may indicate the one or multiple set of RACH resources via other signaling (also referred to as activation signaling herein), including higher-layer signaling (e.g., Layer 3) or lower-layer signaling (e.g., Layer 2, Layer 1). In some examples, the NE 220 may transmit one or more of a SI or an RRC message that includes information (e.g., a parameter, information element (IE), field, bitmap, etc.) that indicates (or activates) one or multiple set of RACH resources. In some other examples, the NE 220 may transmit one or more of a MAC-CE or a DCI that includes information (e.g., a parameter, IE, field, bitmap, etc.) that indicates (or activates) one or multiple set of RACH resources. By way of example, the UE 210 may receive and/or detect a DCI within a common search space (CSS) of a CORESET. The DCI may be addressed to a radio network temporary identifier (RNTI) that is applicable or specific to indicating one or multiple set of RACH resources.

The configuration 230 may include (e.g., indicate) time and frequency resources that define one or multiple set of RACH resources. For example, the configuration 230 may include a periodicity (e.g., a time interval) between different sets of RACH resources and/or a duration for which a corresponding set of RACH resources is available or remains active (e.g., for use for a certain feature or purpose). This allows the UE 210 to determine when the UE 210 can attempt random access using a specific set of RACH resources and how long that opportunity lasts before the set of RACH resources are deactivated or reconfigured.

In some examples, one or multiple set of RACH resources may be associated with a specific type of RACH procedure, such as a contention-based random access procedure (CBRA) or a contention-free random access procedure (CFRA). Thus, when the UE 210 initiates a CBRA procedure or a CFRA procedure, the UE 210 may select and utilize a set of RACH resources of the multiple set of RACH resource associated with the specific type of RACH procedure.

In some examples, one or multiple set of RACH resources may be associated with a first cell and/or a first BWP of the NE 220, while another set of RACH resources may be associated with a second cell and/or a second BWP. A specific set of RACH resources may be applicable to any cell and/or any BWP of the NE 220 (e.g., a first cell and a second BWP). This allows the NE 220 to configure RACH configurations based on specific characteristics or requirements of each cell or BWP. For example, a macro cell operating on a lower frequency band may be assigned one set of RACH resources, while a small cell or high-frequency millimeter wave (mmWave) cell may use a different set of RACH resources. Similarly, one BWP may be configured for enhanced mobile broadband (eMBB) services, while another BWP supports RedCap UEs or low latency traffic, each with service being associated with a corresponding RACH configuration.

In some cases, a bandwidth associated with the UE 210 may be smaller than a total bandwidth of a cell of the NE 220. In these cases, the bandwidth may be adjusted (e.g., modified) by one or more of the UE 210 or the NE 220. For example, the bandwidth may be reduced during one or more periods of low activity to save power for the UE 210 and/or the NE 220, the bandwidth may be shifted in the frequency domain to increase scheduling flexibility, and/or the bandwidth may be adjusted in terms of subcarrier spacing (SCS) to accommodate and support different services. A subset of the total bandwidth of the cell of the NE 220 may be referred to as a BWP, and such bandwidth adaptation may be achieved by configuring the UE 210 with one or more BWPs. The UE 210 may be configured to select or identify an active BWP from a group of BWPs. Prior to being configured (e.g., receiving the configuration 230), the UE 210 may obtain an initial BWP from information transmitted in a MIB or a SIB by the NE 220.

In some examples, when the UE 210 fulfills (e.g., completes) a feature or purpose associated with a set of RACH resources, the UE 210 may prioritize a transmission on a resource from the set of RACH resources over another transmission on another resource of a different set of RACH resources (e.g., the default set). For example, in response to determining that a specific set of resources is configured exclusively for a certain feature or a certain purpose, the UE 210 may select and use a resource from the specific set of resources during procedures associated with the certain feature or the certain purpose.

In some examples, the UE 210 may select a set of resources based on a reference signal measurement value, such as an RSRP value and/or an RSSI value, satisfying a threshold value. For example, the UE 210 may measure signal strength and select a set of resources based on whether the measured signal strength value being greater than or equal to a threshold value. As another example, the UE 210 may select a set of resources that is not associated with any threshold value and/or signal quality measurements.

Using a selected set of resources, the UE 210 may perform a random access transmission 235, such as a PRACH preamble transmission. The UE 210 may perform the random access transmission 235 for various purposes or procedures, including but not limited to, an initial access (e.g., from an RRC idle state) procedure, an RRC connection re-establishment procedure, a handover procedure, a synchronization or a time alignment purpose, a SI request, a beam failure recovery, an on-demand SIB1 request, a wake-up procedure, and so on.

In some examples, when a RACH procedure using a RACH resource from a selected set (e.g., a second set) of RACH resources fails, for example, due to a preamble collision (e.g., a failed contention resolution), the UE 210 may repeat a RACH transmission (or the RACH procedure) using a RACH resource from a different set (e.g., a first set) of RACH resources. For example, the UE 210 may repeat a RACH transmission (or the RACH procedure) using a resource from the first set of RACH resources, after a specific number of failed RACH transmissions (e.g., associated with a contention resolution phase of the RACH procedure) attempts using a resource from the second set of RACH resources.

In some cases, the repetition of the random access transmission may use the same information (e.g., the same RACH preamble) or different information (e.g., a different PRACH preamble). For example, a different signal may be used when an original signal transmitted on a resource from the first set of RACH resources is not supported or available on a resource from the second set of RACH resources, such as when the PRACH preamble transmitted on the resource from the first set of RACH resources is not included as a candidate PRACH preamble configured for resources from the second set of RACH resources.

In some examples, the UE 210 may disable a set of RACH resources when a RACH procedure (or a contention resolution phase of the RACH procedure) fails using one of the RACH resources of the set of RACH resources. The UE 210 may enable (or re-enable) a disabled set of RACH resources after a specific time (e.g., based at least in part on the configuration 230) and/or based at least in part on an activation indication received from the NE 220. For example, the UE 210 may disable a second set of RACH resources after a RACH procedure (or a contention resolution phase of the RACH procedure) fails a threshold number of times when using one or more resources of the second set of RACH resources.

In some cases, the UE 210 may transmit information to the NE 220 that includes information indicative of an enabled or disabled states of one or multiple sets of RACH resources. The information may indicate a change in the enabled or disabled states of a set of RACH resources and/or whether one or more sets of RACH resources are enabled or disabled. The UE 210 may transmit the information in response to a triggering event, such as a state change of at least one set of RACH resources and/or a request received from the NE 220. The information may be provided via uplink control information (UCI) or a MAC-CE.

In some examples, the UE 210 may receive a random access response (RAR) that includes an indication for a set of RACH resources (e.g., a RACH resource set indicator (RRSI)). The RRSI may indicate the set of RACH resources to use during another random access procedure transmission, such as a preamble transmission, and may include an identifier for the set of RACH resources. In some cases, the RRSI may indicate whether a first set of RACH resources or a second set of RACH resources is to be selected and used during or for another random access procedure transmission (e.g., a preamble transmission). The NE 220 may include the RSSI (or another indicator) in a MAC subheader (with a backoff indicator (BI)) of the RAR message. The BI may indicate a duration (e.g., how long the UE 210 has to wait) before attempting another random access procedure after a failure (e.g., due to preamble collision or contention resolution failure).

The NE 220, therefore, may control and/or manage the UE 210 to select and/or utilize a certain set of RACH resources (e.g., to change from one set to a different set of RACH resources), which may facilitate a lower risk of collisions during a subsequent preamble transmission. Thus, when the NE 220 detects a collision of RACH preambles transmitted by different UEs using a first set of RACH resources, the NE 220 may indicate that, for any subsequent preamble transmissions, the UE 210 may use RACH resources from a second set of RACH resources. For example, the second set of RACH resources may include more resources than the first set of RACH resources, reducing the risk of another collision of transmissions. In some examples, the UE 210 selects a first RACH resource from a first set of RACH resources associated with a first feature combination and transmits a PRACH preamble using the first RACH resource when a random access procedure associated with a first feature combination set is triggered at the UE 210.

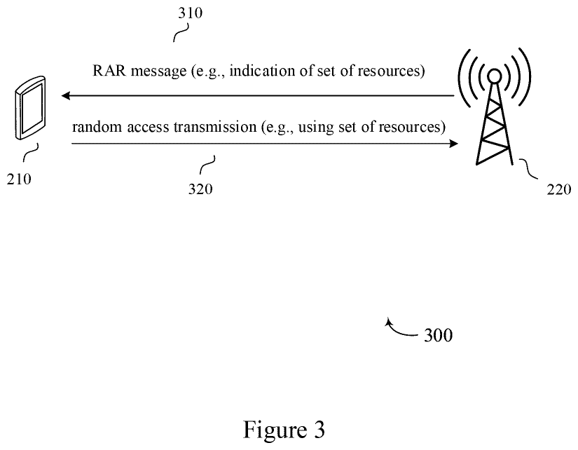

FIG. 3 illustrates example communications during a random access procedure 300 in accordance with aspects of the present disclosure.

In response to the PRACH preamble transmission, the UE 210 receives a random access response (RAR) message 310 (e.g., a physical downlink shared channel (PDSCH) scheduled by DCI with a cyclic redundancy code (CRC) scrambled with RA-RNTI) that includes an indication of a second set of resources for the first feature combination. For example, the RAR message 310 is received within an RAR window and does not carry a MAC subheader with a random access preamble identifier (RAPID) corresponding to the transmitted PRACH preamble. Instead, the RAR message 310 carries a MAC subheader with an indication of the second set of RACH resources to be associated with the first feature combination.

The UE 210 selects a RACH resource from the indicated second set of RACH resources associated with the first feature combination and transmits (re-transmits) a random access transmission 320 (e.g., a PRACH preamble) using the RACH resource selected from the indicated second set of RACH resources. In some cases, a RACH resource associated with the first feature combination may be a RACH resource configured with the first feature combination or a RACH resource configured with a second feature combination, where the second feature combination is a subset of the first feature combination.

In some examples, the NE 220 may configure a smaller number (e.g., fewer) of RACH resources (e.g., a smaller number of PRACH occasions and/or PRACH preambles) for a specific feature or feature combination, with respect to a number of RACH resources not associated with any feature (e.g., RACH resources configured for general or all purposes or features). However, when a quantity of UEs performing a random access procedure associated with the specific feature increases, the probability of a RACH failure due to PRACH preamble collisions may increase. The NE 220 may detect a high number of random access attempts in a PRACH occasion associated with the specific feature (e.g., based on a received signal strength) and/or may detect PRACH preamble collisions (e.g., based on multiple peak positions in PRACH preamble correlation) and determine to provide an additional set of RACH resources for the specific feature (or feature combination).

For example, the NE 220 may provide additional sets of RACH resources associated with the specific feature (or feature combination) by activating (via an activation signal) RACH resources configured at the UE 210 by an additional RACH configuration. The additional set of RACH resources may be converted from other sets of RACH resources not associated with any feature to one or more sets of RACH resources associated with the specific feature (or feature combination). The conversion may associate the set of RACH resources with the specific feature (or feature combination) for a certain duration and/or indefinitely.

In some examples, the UE 210 may receive an indication of a selection probability (or other statistic) for each set of RACH resources. For example, the statistic may represent a likelihood of selection, for a given set of RACH resources, for PRACH preamble transmission (or retransmission). The NE 220 may indicate, via the MAC subheader of the RAR message 310, the selection probabilities assigned to the sets of RACH resources.

Using the assigned statistics, the UE 210 determines or selects a set of RACH resources set for a subsequent PRACH preamble retransmission. For example, the UE 210 may generate a random number (according to a uniform distribution between 0 and 1) and select a set of RACH resources based on the generated random number and/or the assigned probabilities (e.g., a second set of RACH resources has a probability of 0.7 and is selected whenever the generated random number is not larger than 0.7).

In some examples, the NE 220 may configure a same number of RACH resources for every synchronization signal block (SSB) of an SSB burst in a default RACH configuration. When the NE 220 detects a high number of random access attempts in a PRACH occasion associated with a particular SSB and/or detects PRACH preamble collisions for preambles associated with the SSB, the NE 220 may determine to provide or convert an additional set of RACH resources to be associated with the SSB.

In some examples, the UE 210 may include a list of sets of RACH resources that may be activated via a MAC subheader carried by a RAR PDSCH (e.g., the RAR message 310). For example, a 1-bit field in the MAC subheader may correspond to one set of RACH resources, where each set of RACH resources is associated with a specific feature combination and/or a specific spatial relation (e.g., an index of SSB or an index of a channel state information reference signal (CSI-RS) resource). As another example, the MAC subheader and/or a MAC subPDU may include an indication of a set of RACH resources selected from the list of sets of RACH resources and an indication of a feature combination and/or a spatial relation corresponding to the selected set of RACH resources.

Thus, the spatial relation and/or the feature combination may be dynamically associated with a dynamically activated set of RACH resources. When the UE 210 receives an activation indication for a set of RACH resources in the RAR PDSCH (e.g., the RAR message 310), the UE 210 may determine that the set of RACH resources is available for a subsequent PRACH preamble re-transmission for a configured duration and/or as long as an activation validity timer is running.

In some cases, a paging DCI indicates availability of a full set or a subset of PRACH occasions associated with an additional RACH configuration. The reference point of the availability may be a start of a first frame of a current SI modification period (e.g., a period within which SI modifications may occur) when the paging DCI is received. The validity duration for the availability information may be a multiple of the SI modification period.

In some cases, a subset of additional configured RACH resources may be activated via the RAR message 310. These additional RACH resources may be available after the reception of the RAR message 310 (e.g., with a small (<1 ms) processing delay), which facilitate a quick and efficient adjustment of PRACH resources (e.g., conversion or association of sets of resources to certain features, feature combinations, and so on).

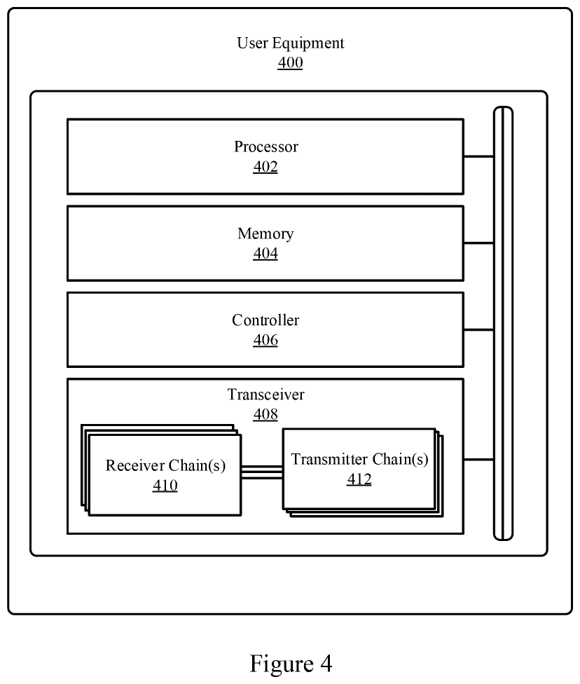

FIG. 4 illustrates an example of a UE 400 in accordance with aspects of the present disclosure. The UE 400 may include a processor 402, a memory 404, a controller 406, and a transceiver 408. The processor 402, the memory 404, the controller 406, or the transceiver 408, or various combinations thereof or various components thereof may be examples of means for performing various aspects of the present disclosure as described herein. These components may be coupled (e.g., operatively, communicatively, functionally, electronically, electrically) via one or more interfaces.

The processor 402, the memory 404, the controller 406, or the transceiver 408, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 402 may include an intelligent hardware device (e.g., a general-purpose processor, a DSP, a CPU, an ASIC, an FPGA, or any combination thereof). In some implementations, the processor 402 may be configured to operate the memory 404. In some other implementations, the memory 404 may be integrated into the processor 402. The processor 402 may be configured to execute computer-readable instructions stored in the memory 404 to cause the UE 400 to perform various functions of the present disclosure.

The memory 404 may include volatile or non-volatile memory. The memory 404 may store computer-readable, computer-executable code including instructions when executed by the processor 402 cause the UE 400 to perform various functions described herein. The code may be stored in a non-transitory computer-readable medium such the memory 404 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 402 and the memory 404 coupled with the processor 402 may be configured to cause the UE 400 to perform one or more of the functions described herein (e.g., executing, by the processor 402, instructions stored in the memory 404). For example, the processor 402 may support wireless communication at the UE 400 in accordance with examples as disclosed herein. The UE 400 may be configured to support a means for selecting a set of resources of a plurality of sets of resources for random access based at least in part on a criteria and performing random access based at least in part on the selected set of resources.

The controller 406 may manage input and output signals for the UE 400. The controller 406 may also manage peripherals not integrated into the UE 400. In some implementations, the controller 406 may utilize an operating system such as iOS®, ANDROID®, WINDOWS®, or other operating systems. In some implementations, the controller 406 may be implemented as part of the processor 402.

In some implementations, the UE 400 may include at least one transceiver 408. In some other implementations, the UE 400 may have more than one transceiver 408. The transceiver 408 may represent a wireless transceiver. The transceiver 408 may include one or more receiver chains 510, one or more transmitter chains 412, or a combination thereof.

A receiver chain 410 may be configured to receive signals (e.g., control information, data, packets) over a wireless medium. For example, the receiver chain 410 may include one or more antennas for receive the signal over the air or wireless medium. The receiver chain 410 may include at least one amplifier (e.g., a low-noise amplifier (LNA)) configured to amplify the received signal. The receiver chain 410 may include at least one demodulator configured to demodulate the receive signal and obtain the transmitted data by reversing the modulation technique applied during transmission of the signal. The receiver chain 410 may include at least one decoder for decoding the processing the demodulated signal to receive the transmitted data.

A transmitter chain 412 may be configured to generate and transmit signals (e.g., control information, data, packets). The transmitter chain 412 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 412 may also include at least one power amplifier configured to amplify the modulated signal to an appropriate power level suitable for transmission over the wireless medium. The transmitter chain 412 may also include one or more antennas for transmitting the amplified signal into the air or wireless medium.

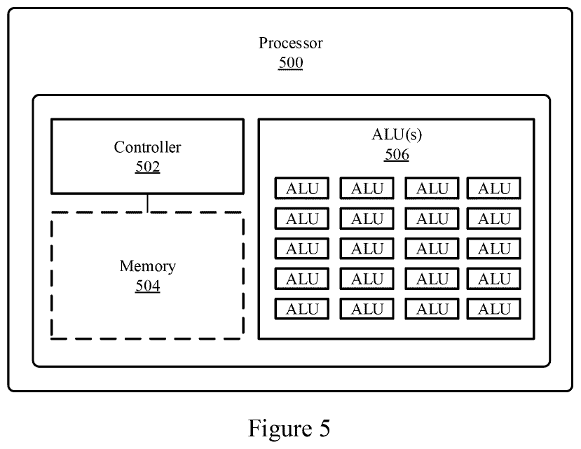

FIG. 5 illustrates an example of a processor 500 in accordance with aspects of the present disclosure. The processor 500 may be an example of a processor configured to perform various operations in accordance with examples as described herein. The processor 500 may include a controller 502 configured to perform various operations in accordance with examples as described herein. The processor 500 may optionally include at least one memory 504, which may be, for example, an L1/L2/L3 cache. Additionally, or alternatively, the processor 500 may optionally include one or more arithmetic-logic units (ALUs) 506. One or more of these components may be in electronic communication or otherwise coupled (e.g., operatively, communicatively, functionally, electronically, electrically) via one or more interfaces (e.g., buses).

The processor 500 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 500) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 502 may be configured to manage and coordinate various operations (e.g., signaling, receiving, obtaining, retrieving, transmitting, outputting, forwarding, storing, determining, identifying, accessing, writing, reading) of the processor 500 to cause the processor 500 to support various operations in accordance with examples as described herein. For example, the controller 502 may operate as a control unit of the processor 500, generating control signals that manage the operation of various components of the processor 500. These control signals include enabling or disabling functional units, selecting data paths, initiating memory access, and coordinating timing of operations.

The controller 502 may be configured to fetch (e.g., obtain, retrieve, receive) instructions from the memory 504 and determine subsequent instruction(s) to be executed to cause the processor 500 to support various operations in accordance with examples as described herein. The controller 502 may be configured to track memory address of instructions associated with the memory 504. The controller 502 may be configured to decode instructions to determine the operation to be performed and the operands involved. For example, the controller 502 may be configured to interpret the instruction and determine control signals to be output to other components of the processor 500 to cause the processor 500 to support various operations in accordance with examples as described herein. Additionally, or alternatively, the controller 502 may be configured to manage flow of data within the processor 500. The controller 502 may be configured to control transfer of data between registers, arithmetic logic units (ALUs), and other functional units of the processor 500.

The memory 504 may include one or more caches (e.g., memory local to or included in the processor 500 or other memory, such RAM, ROM, DRAM, SDRAM, SRAM, MRAM, flash memory, etc. In some implementations, the memory 504 may reside within or on a processor chipset (e.g., local to the processor 500). In some other implementations, the memory 504 may reside external to the processor chipset (e.g., remote to the processor 500).

The memory 504 may store computer-readable, computer-executable code including instructions that, when executed by the processor 500, cause the processor 500 to perform various functions described herein. The code may be stored in a non-transitory computer-readable medium such as system memory or another type of memory. The controller 502 and/or the processor 500 may be configured to execute computer-readable instructions stored in the memory 504 to cause the processor 500 to perform various functions. For example, the processor 500 and/or the controller 502 may be coupled with or to the memory 504, the processor 500, the controller 502, and the memory 504 may be configured to perform various functions described herein. In some examples, the processor 500 may include multiple processors and the memory 504 may include multiple memories. One or more of the multiple processors may be coupled with one or more of the multiple memories, which may, individually or collectively, be configured to perform various functions herein.

The one or more ALUs 506 may be configured to support various operations in accordance with examples as described herein. In some implementations, the one or more ALUs 506 may reside within or on a processor chipset (e.g., the processor 500). In some other implementations, the one or more ALUs 506 may reside external to the processor chipset (e.g., the processor 500). One or more ALUs 506 may perform one or more computations such as addition, subtraction, multiplication, and division on data. For example, one or more ALUs 506 may receive input operands and an operation code, which determines an operation to be executed. One or more ALUs 506 be configured with a variety of logical and arithmetic circuits, including adders, subtractors, shifters, and logic gates, to process and manipulate the data according to the operation. Additionally, or alternatively, the one or more ALUs 506 may support logical operations such as AND, OR, exclusive-OR (XOR), not-OR (NOR), and not-AND (NAND), enabling the one or more ALUs 506 to handle conditional operations, comparisons, and bitwise operations.

The processor 500 may support wireless communication in accordance with examples as disclosed herein. For example, the processor 500 may be configured to support a means for selecting a set of resources of a plurality of sets of resources for random access based at least in part on criteria and performing random access based at least in part on the selected set of resources.

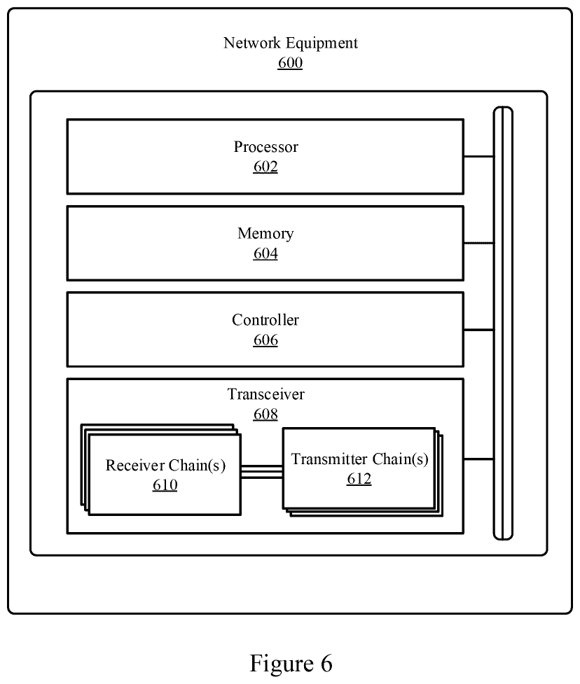

FIG. 6 illustrates an example of a NE 600 in accordance with aspects of the present disclosure. The NE 600 may include a processor 602, a memory 504, a controller 606, and a transceiver 608. The processor 602, the memory 504, the controller 606, or the transceiver 608, or various combinations thereof or various components thereof may be examples of means for performing various aspects of the present disclosure as described herein. These components may be coupled (e.g., operatively, communicatively, functionally, electronically, electrically) via one or more interfaces.

The processor 602, the memory 604, the controller 606, or the transceiver 608, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 602 may include an intelligent hardware device (e.g., a general-purpose processor, a DSP, a CPU, an ASIC, an FPGA, or any combination thereof). In some implementations, the processor 602 may be configured to operate the memory 604. In some other implementations, the memory 604 may be integrated into the processor 602. The processor 602 may be configured to execute computer-readable instructions stored in the memory 604 to cause the NE 600 to perform various functions of the present disclosure.

The memory 604 may include volatile or non-volatile memory. The memory 604 may store computer-readable, computer-executable code including instructions when executed by the processor 602 cause the NE 600 to perform various functions described herein. The code may be stored in a non-transitory computer-readable medium such the memory 604 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 602 and the memory 604 coupled with the processor 602 may be configured to cause the NE 600 to perform one or more of the functions described herein (e.g., executing, by the processor 602, instructions stored in the memory 604).

For example, the processor 602 may support wireless communication at the NE 600 in accordance with examples as disclosed herein. The NE 600 may be configured to support a means for determining selection criteria for each of one or more sets of resources of a plurality of sets of resources for random access and transmitting, to a UE, a configuration of the plurality of sets of resources for random access.

The controller 606 may manage input and output signals for the NE 600. The controller 606 may also manage peripherals not integrated into the NE 600. In some implementations, the controller 606 may utilize an operating system such as iOS®, ANDROID®, WINDOWS®, or other operating systems. In some implementations, the controller 606 may be implemented as part of the processor 602.

In some implementations, the NE 600 may include at least one transceiver 608. In some other implementations, the NE 600 may have more than one transceiver 608. The transceiver 608 may represent a wireless transceiver. The transceiver 608 may include one or more receiver chains 610, one or more transmitter chains 612, or a combination thereof.

A receiver chain 610 may be configured to receive signals (e.g., control information, data, packets) over a wireless medium. For example, the receiver chain 610 may include one or more antennas for receive the signal over the air or wireless medium. The receiver chain 610 may include at least one amplifier (e.g., a low-noise amplifier (LNA)) configured to amplify the received signal. The receiver chain 610 may include at least one demodulator configured to demodulate the receive signal and obtain the transmitted data by reversing the modulation technique applied during transmission of the signal. The receiver chain 610 may include at least one decoder for decoding the processing the demodulated signal to receive the transmitted data.

A transmitter chain 612 may be configured to generate and transmit signals (e.g., control information, data, packets). The transmitter chain 612 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 612 may also include at least one power amplifier configured to amplify the modulated signal to an appropriate power level suitable for transmission over the wireless medium. The transmitter chain 612 may also include one or more antennas for transmitting the amplified signal into the air or wireless medium.

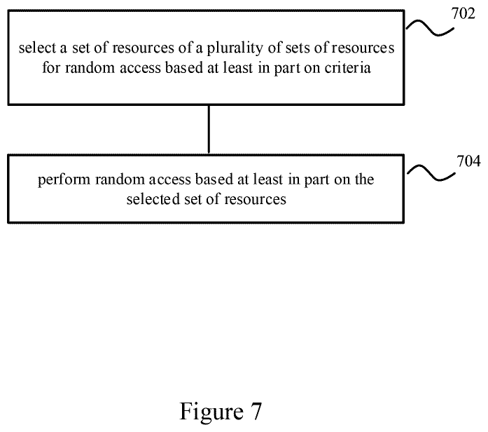

FIG. 7 illustrates a flowchart of a method in accordance with aspects of the present disclosure. The operations of the method may be implemented by a UE as described herein. In some implementations, the UE may execute a set of instructions to control the function elements of the UE to perform the described functions.

At 702, the method may include selecting a set of resources of a plurality of sets of resources for random access based at least in part on criteria. The operations of 702 may be performed in accordance with examples as described herein. In some implementations, aspects of the operations of 702 may be performed by a UE as described with reference to FIG. 4.

At 704, the method may include performing random access based at least in part on the selected set of resources. The operations of 704 may be performed in accordance with examples as described herein. In some implementations, aspects of the operations of 704 may be performed by a UE as described with reference to FIG. 4.

It should be noted that the method described herein describes a possible implementation, and that the operations and the steps may be rearranged or otherwise modified and that other implementations are possible.

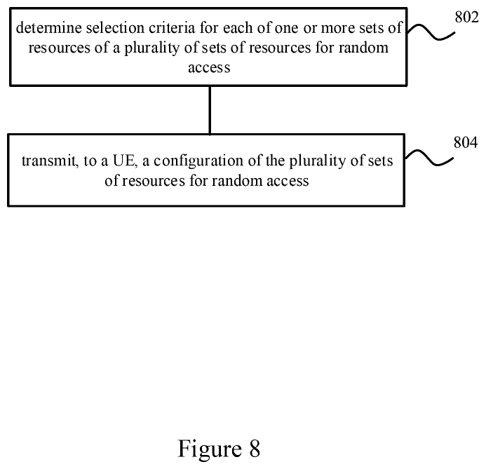

FIG. 8 illustrates a flowchart of a method in accordance with aspects of the present disclosure. The operations of the method may be implemented by an NE as described herein. In some implementations, the NE may execute a set of instructions to control the function elements of the NE to perform the described functions.

At 802, the method may include determining selection criteria for each of one or more sets of resources of a plurality of sets of resources for random access. The operations of 802 may be performed in accordance with examples as described herein. In some implementations, aspects of the operations of 902 may be performed by an NE as described with reference to FIG. 6.

At 804, the method may include transmitting, to a UE, a configuration of the plurality of sets of resources for random access. The operations of 804 may be performed in accordance with examples as described herein. In some implementations, aspects of the operations of 804 may be performed by an NE as described with reference to FIG. 6.

It should be noted that the method described herein describes a possible implementation, and that the operations and the steps may be rearranged or otherwise modified and that other implementations are possible.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE) for wireless communication, comprising:
one or more memories; and
one or more processors coupled with the one or more memories and individually or collectively configured to cause the UE to:
select a set of resources of a plurality of sets of resources for random access based at least in part on criteria; and
perform random access based at least in part on the selected set of resources.

2. The UE of claim 1, wherein the criteria comprise one or more of a feature associated with random access, a purpose associated with random access, a feature combination associated with random access, or spatial relation associated with random access, and
wherein the set of resources is selected based at least in part on the feature associated with random access, the purpose associated with random access, the feature combination associated with random access, or the spatial relation associated with random access.

3. The UE of claim 1, wherein the one or more processors are further individually or collectively configured to cause the UE to:
receive a configuration for each of one or more sets of resources of the plurality of sets of resources,
wherein the configuration is received in a radio resource control (RRC) message.

4. The UE of claim 3, wherein the one or more processors are further individually or collectively configured to cause the UE to:
receive information for each of one or more sets of resources of the plurality of sets resources,
wherein the set of resources is selected based at least in part on the received information, and wherein the information is received in system information (SI), downlink control information (DCI), or a medium access control-control element (MAC-CE).

5. The UE of claim 4, wherein the one or more processors are further individually or collectively configured to cause the UE to:
determine a control resource set (CORESET); and
receive the DCI based at least in part on the determined CORESET,
wherein the DCI activates one or more sets of resources of the plurality of sets of resources, and wherein the set of resources is selected based at least in part on the received DCI.

6. The UE of claim 4, wherein one or more of the received configuration or the received information indicates a respective periodicity associated with each of one or more sets of resources of the plurality of sets resources, indicates whether each of one or more sets of resources of the plurality of sets resources is activated or deactivated for random access, indicates a respective duration indicative of each of one or more sets of resources of the plurality of sets resources being activated or deactivated for random access, or a combination thereof.

7. The UE of claim 1, wherein the one or more processors are further individually or collectively configured to cause the UE to:
determine a type of random access procedure, wherein the type of random access procedure includes a contention-based random access procedure or a contention-free random access procedure, and
wherein the criteria comprise the type of random access procedure, and wherein the set of resources is selected based at least in part on the determined type of random access procedure.

8. The UE of claim 1, wherein the set of resources is selected based at least in part on a signal measurement value satisfying a threshold value, wherein the signal measurement value comprises a reference signal received power (RSRP) value, a reference signal strength indicator (RSSI) value, or both.

9. The UE of claim 1, wherein the set of resources is selected irrespective of a signal measurement value satisfying a threshold value.

10. The UE of claim 1, wherein each of one or more sets of resources of the plurality of sets resources is associated with a respective cell or a respective bandwidth part (BWP).

11. The UE of claim 1, wherein the one or more processors are further individually or collectively configured to cause the UE to:
receive a random access response during a random access procedure, wherein the random access response includes an indication of the set of resources, wherein the set of resources is selected based at least in part on the random access response; and
perform a random access transmission using the selected set of resources, wherein the selected set of resources are different than a respective set of resources associated with a previous random access transmission.

12. The UE of claim 11, wherein the random access response is received via a physical downlink shared channel (PDSCH) and carries a medium access control (MAC) subheader that indicates the selected set of resources.

13. The UE of claim 1, wherein the set of resources is selected based at least in part on an unsuccessful random access using a different set of resources, wherein the one or more processors are further individually or collectively configured to cause the UE to disable the different set of resources based at least in part on the selected set of resources.

14. The UE of claim 1, wherein the one or more processors are further individually or collectively configured to cause the UE to:
select the set of resources based at least in part on a statistic associated with the set of resources.

15. A network entity for wireless communication, comprising:
one or more memories; and
one or more processors coupled with the one or more memories and individually or collectively configured to cause the UE to:
determine selection criteria for each of one or more sets of resources of a plurality of sets of resources for random access; and
transmit, to a user equipment (UE), a configuration of the plurality of sets of resources for random access.

16. The network entity of claim 15, wherein the plurality of sets of resources includes multiple sets of time or frequency random access channel (RACH) resources, and wherein the one or more processors are further individually or collectively configured to cause the network entity to:
transmit an activation signal that causes activation of at least one set of RACH resources for a certain duration.

17. The network entity of claim 15, wherein the one or more processors are further individually or collectively configured to cause the network entity to:
determine an occurrence of preamble collisions at a first set of resources of the plurality of sets of resources; and
transmit an indication to the UE to select a second set of resources for a subsequent random access procedure.

18. The network entity of claim 15, wherein the one or more processors are further individually or collectively configured to cause the network entity to:
transmit the configuration in system information (SI), downlink control information (DCI), or a medium access control-control element (MAC-CE).

19. A method performed by a user equipment (UE), the method comprising:
selecting a set of resources of a plurality of sets of resources for random access based at least in part on a criteria; and
performing random access based at least in part on the selected set of resources.

20. A method performed by a network entity, the method comprising:
determining selection criteria for each of one or more sets of resources of a plurality of sets of resources for random access; and
transmitting, to a user equipment (UE), a configuration of the plurality of sets of resources for random access.
